(19) United States
(12) Patent Application Publication
(10) Pub. No.: US 2007/0172308 A1
(43) Pub. Date: Jul. 26, 2007

(54) Dual hinged briefcase

(75) Inventors: Daniel Perella, Hudson, OH (US); Anthony DeCarlo, Kirtland, OH (US); Vincent Thomson, Avon Lake, OH (US)

Correspondence Address: PILLSBURY WINTHROP SHAW PITTMAN, LLP, P.O. BOX 10500, MCLEAN, VA, 22102, US

(73) Assignee: IdeaStream Consumer Products, LLC, Parma, OH (US)

(21) Appl. No.: 11/335,711

(22) Filed: Jan. 20, 2006

(51) Int. Cl. B42F 13/00; B42F 13/40; A45C 13/40

(52) U.S. Cl. 402/73; 402/4; 190/102

(57) ABSTRACT

The present invention relates to a dual hinged briefcase capable of being opened such that it creates a flat interior surface.

### FIELD OF THE INVENTION

The present invention relates to a double-hinged briefcase capable of laying generally flat when opened.

### BACKGROUND OF THE INVENTION

Briefcases are typically composed of two sides, or shells, which are pivotally attached at the bottom portions of the shells. Thus, the pivotal connections allow a typical briefcase to open and lay the two sides of the briefcase flat, but the two bottom portions that compose the bottom side of a closed briefcase will orient themselves vertically and separate or divide the two shells from one another.

Often, briefcases are used to transport and protect papers. These papers may be loose within the briefcase or, preferably, attached to a page retainer disposed within the briefcase. These page retainers often take the form of binder rings. If the page retainer is mounted on an internal wall of one side of the briefcase, the pages attached thereto may lay flat on that side when the briefcase is fully opened and laid flat. However, when the user tries to turn the pages over to the other side of the briefcase, the pages cannot lay flat. This is because the two bottom portions that compose the bottom side of a closed briefcase are oriented vertically when the briefcase is fully opened and laid flat. As a result, the pages will have to lay over these vertically oriented portions, causing the pages to arch or bend. This can be problematic if the pages contain fragile documents, or more rigid items, like CD's and/or DVD's.

### SUMMARY OF THE INVENTION

To address this problem, the present invention provides a briefcase with a dual hinge system for enabling its bottom wall to lay flat when the briefcase is fully opened. To achieve this, the present invention provides a briefcase with a first partial shell, a second partial shell, and a bottom wall with first and second opposing lateral edges. A bottom portion of the first partial shell is pivotally connected to a lateral edge of the bottom wall, and a bottom portion of the second partial shell is also pivotally connected to the other lateral edge of the bottom wall. The pivotal connections allow the first and second partial shells to move to a closed position in which the shells are engaged with each other and enclose an interior space. In addition, the pivotal connections allow the first and second partial shells to move into a fully open position, in which the shells extend in opposing directions from one another with the bottom wall between the two shells.

A page retainer is mounted to the interior of one of the partial open shells, adjacent to the bottom wall. The page retainer is designed to receive and retain a plurality of pages. The page retainer is constructed such that, when the briefcase is in a fully open position, one or more of the pages retained by the page retainer can be laid on the first partial shell while one or more other pages can be laid over the bottom wall and at least partially over the second partial shell.

Although a briefcase is typically shaped as a rectangular solid, the present invention is not so limited. The briefcase can be made of any number of materials, including aluminum, plastic, leather, or any combination thereof. The sides of the briefcase can be any shape, so long as the bottom of the briefcase is structured as described below. For example, the present invention could employ semi-elliptical sides with rounded edges and without distinct side-walls, but employing a flat bottom side that enables the briefcase to lay flat when opened.

The briefcase may also have a handle disposed on the top side of the briefcase when closed. This will allow for easier carrying. In addition, the interior surfaces of the briefcase may be covered with any sort of material for protective or aesthetic purposes. The interior walls of the sides of the invention may have a strap to retain the pages when the briefcase is closed, preferably located on the same interior wall as the page retainer. A pocket made of any material may be on either interior wall to provide storage.

As with many briefcases, a locking mechanism may be employed on the top side to provide a way to secure the contents of the briefcase. The locking mechanism can be in the form of a combination lock, keyed lock, or any other mechanism so suited. Because the briefcase is designed to be laid down on a surface and opened, rubber feet may be employed to protect against wear and to provide slip resistance when placed upon an uneven surface. Finally, because the corners of briefcases are often the source of the most wear, protective covers for the corners may be used to provide protection from excessive wear.

Other objects, features, and advantages of the present invention will be appreciated from the following detailed description, the accompanying drawings, and the appended claims.

### BRIEF DESCRIPTION OF THE DRAWINGS

FIG. 1 is a side perspective of a briefcase in a closed and upright position;

FIG. 2 is a side perspective of the briefcase of FIG. 1 in a partially open position; and

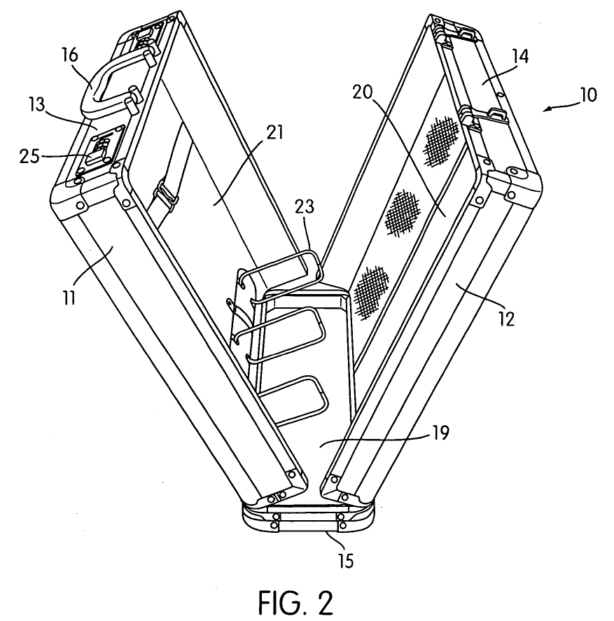

FIG. 3 is a side perspective of the briefcase of FIG. 1 in an open position; and

FIG. 4 is a side perspective of the briefcase of FIG. 1 in an open position.

### DETAILED DESCRIPTION OF ILLUSTRATED EMBODIMENT OF THE INVENTION

The Figures illustrate a briefcase 10, with a first partial shell 11 and a second partial shell 12. When closed, the top wall of the briefcase 10 is formed by a top portion of the first partial shell 13 and a top portion of the second partial shell 14, which engage together. The bottom of the briefcase 10 is formed by bottom wall 15. Bottom wall 15 has a first lateral edge 28 pivotally connected to the first partial shell 11 and a second lateral edge 29 pivotally connected to the second partial shell 12.

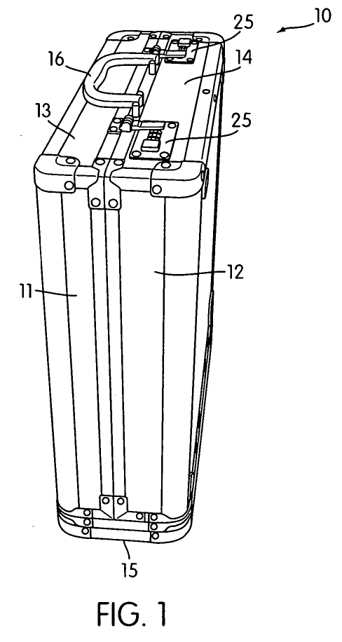

A handle 16 is fixed to the top portion of the first partial shell 13. Locking mechanisms 25 are positioned such that top portion of the first partial shell 13 and top portion of the second partial shell 14 may be lockably engaged with one another. Feet 20 can be affixed to the first partial shell 11, the second partial shell 12, and the bottom wall 15 to provide protection for the surfaces of the briefcase 10. When the briefcase 10 is closed, as shown in FIG. 1, the feet 20 can contact the ground and stably support the briefcase in an upright position as illustrated

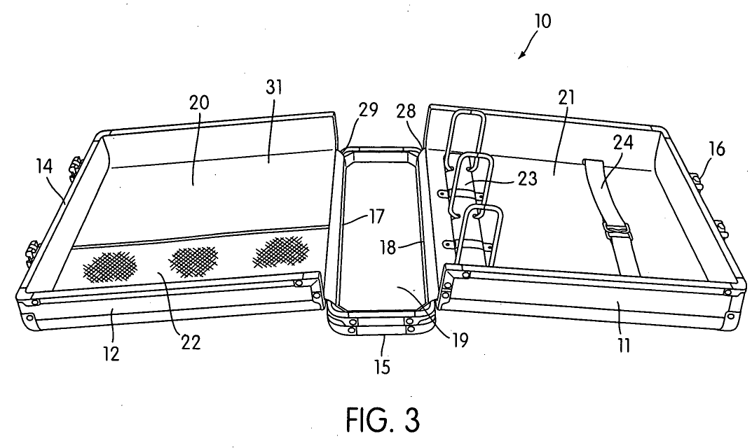

When opened, the briefcase 10 is capable of laying flat such that inner wall of the first partial shell 21, the inner wall of the second partial shell 20, and the inner wall of the bottom wall 19 are oriented in generally the same horizontal plane. The bottom wall 15 is positioned between the first partial shell 11 and the second partial shell 12 when the briefcase 10 is in an open position. Specifically, the bottom wall 15 lays flat extending between the two partial shells 11, 13, with the first and second partial shells extending in opposing directions away from one another (and the bottom wall 15), as shown in FIG. 3. The bottom portion of the first partial shell 11 is attached to the first lateral edge 28 of bottom wall 15 by a pivotal attachment 18. The bottom portion of the second partial shell 12 is attached to the second lateral edge 29 of bottom wall 15 by a pivotal attachment 17. Pivotal attachment 17 and pivotal attachment 18 can take the form of a butt hinge, a butterfly hinge, a flush hinge, a barrel hinge, a concealed hinge, a continuous or piano hinge, or any other type of hinging apparatus. Additionally, pivotal attachments 17 and 18 can be formed from a piece of flexible material.

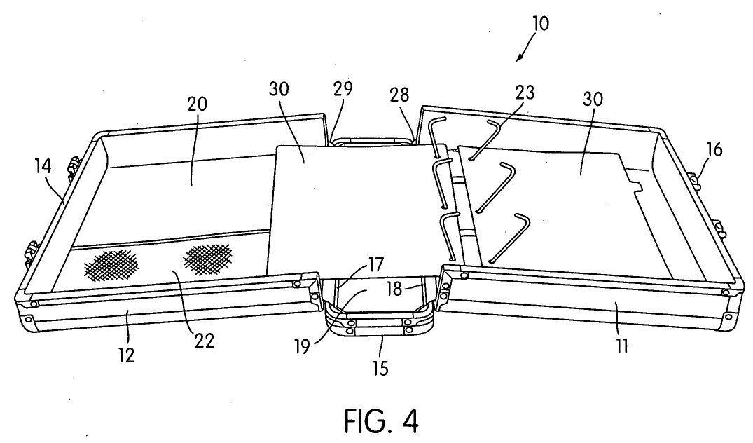

Mounted on the interior wall of the first partial shell 21 is a page retainer 23. Page retainer 23 may also be mounted on the interior wall of the second partial shell 20, or on the interior wall of the bottom wall 19. Page retainer 23 is configured to receive and retain a plurality of pages 30 by engaging the pages through a plurality of holes. The page retainer 23 thereby allows the pages 30 to be turned about an axis defined by the page retainer 23, similar to how pages in a binder can be turned by repositioning the pages from one side of a binder ring to another side. The positioning of page retainer 23 allows the pages 30 to be repositioned from laying flat upon the interior wall of the first partial shell 21 to laying flat upon both the interior wall of the bottom wall 19 and the interior wall of the second partial shell 20. FIG. 4 provides a perspective view of the briefcase 10 in which pages 30 are retained by page retainer 23. The page retainer 23 in FIG. 4 is in an open position to receive pages 30. In FIG. 4, the pages 30 are laid out over bottom wall 15 in contact with the interior wall of the bottom wall 19 and the interior wall of the second partial shell 20.

A retaining strap 24 is attached to either the interior wall of the first partial shell 21, the interior wall of the second partial shell 20, or both. A storage pocket 22 is also attached to the either the interior wall of the first partial shell 21, the interior wall of the second partial shell 20, or both. The interior walls of briefcase 10 can be covered with a protective material 31 that can provide protection from abrasion, sound deadening, or serve merely aesthetic purposes.

The pages 30 may be of any type. For example, they may include protective document sleeves or pouches for receiving documents, typical paper pages, CD or DVD storage sleeves with multiple pockets for receiving CD's/DVD's, etc. The pages 30 may mount in any manner to the page retainer 23. For example, where the page retainer 23 is of the standard three-ring binder type illustrated, the pages 30 may have three holes formed at corresponding locations on their marginal edges, as is well known in the art.

The foregoing illustrated embodiment has been provided solely for the purpose of illustrating the structural and functional principles of the present invention, and it is not intended to be limiting. To the contrary, the present invention is intended to encompass all variables, modifications, alterations, substitutions, and equivalents within the spirit and scope of the following claims.

What is claimed:

1. A briefcase comprising:
a first partial shell,
a second partial shell,
a bottom wall having first and second opposing lateral edges, a bottom portion of the first partial shell being pivotally connected to the first lateral edge of the bottom wall, a bottom portion of the second partial shell being pivotally connected to the second lateral edge of the bottom wall;
the first and second partial shells being movable to a closed position in engagement with one another to enclose an interior space bounded by the partial shells and the bottom wall;
the first and second partial shells being movable to a fully open position extending in opposing directions from one another with the bottom wall therebetween;
a page retainer mounted to the first partial shell adjacent the bottom wall, the page retainer being constructed to receive a plurality of pages thereon,
the page retainer also being constructed such that, when the partial shells are in the open position, one or more of the pages can be laid on the first partial shell, and one or more other pages can be laid over the bottom wall and into the second partial shell; and
a handle connected to an upper portion of at least one of the first and second partial shell.

2. The briefcase of claim 1, further comprising a lock, wherein the first partial shell and the second partial shell are lockably engaged together in the fully closed position by the lock.

3. The briefcase of claim 1, wherein the side of the first partial shell has protective feet disposed thereon to protect the side of the first partial shell.

4. The briefcase of claim 1, wherein the side of the second partial shell has protective feet disposed thereon to protect the side of the first partial shell.

5. The briefcase of claim 1, wherein the bottom wall has protective feet disposed thereon to protect the bottom.

6. The briefcase of claim 1, wherein at least one interior wall of said briefcase has a retaining strap attached thereto.

7. The briefcase of claim 1, wherein at least one interior wall of said briefcase has a storage pocket attached thereto.

8. The briefcase of claim 1, wherein the interior walls of said briefcase are covered with a protective material or fabric.

9. The briefcase of claim 1, wherein said briefcase is made primarily of aluminum.
